(19) United States
(12) Patent Application Publication
(10) Pub. No.: US 2014/0359127 A1
(43) Pub. Date: Dec. 4, 2014

(54) ZERO TOUCH DEPLOYMENT OF PRIVATE CLOUD INFRASTRUCTURE

(71) Applicant: Microsoft Corporation, Redmond, WA (US)

(72) Inventors: Hector Linares, Bellevue, WA (US); Eric Wolz, Bothell, WA (US); Madhusudhan R. Jujare, Santa Clara, CA (US); Cheng Wei, Issaquah, WA (US); Zachary D. Pepin, Redmond, WA (US); Arindam Chakraborty, Seattle, WA (US); Mahmoud Ahmed Abdel-Fattah, Redmond, WA (US); Amit Virmani, Sunnyvale, CA (US); Scott Seligman, Palo Alto, CA (US)

(21) Appl. No.: 13/919,903

(22) Filed: Jun. 17, 2013

Related U.S. Application Data
(60) Provisional application No. 61/830,427, filed on Jun. 3, 2013.

(51) Int. Cl. H04L 12/911

(52) U.S. Cl. CPC H04L 47/70
USPC 709/226

(57) ABSTRACT

Automatically provisioning computing resources based on events occurring in the computer network. The system manager defines resource configurations for computing resources in a network computing environment. The resource configurations are associated with event conditions. The event conditions cause the system manager to apply the resource configurations to the computing resources. The event conditions are also associated with various policies. The policies specify how the resource configurations are to be applied to the computing resources. The occurrence of the event conditions is ascertained. In response, workflows are automatically executed. The workflows apply the resource configurations to the computing resources in accordance with the policies. This configures the computing resources according to the resource configurations.

### CROSS-REFERENCE TO RELATED APPLICATIONS

This application claims the benefit of U.S. Provisional Patent Application No. 61/830,427 filed Jun. 3, 2013, entitled “ZERO TOUCH DEPLOYMENT OF PRIVATE CLOUD INFRASTRUCTURE”, which is incorporated herein by reference in its entirety.

### BACKGROUND

In a typical data center environment, adding or changing infrastructure requires multiple user interaction with the management software to discover or configure the application settings and requirements of the resource provisioning for the applications. In addition, complex applications require administrators to configure various components throughout the data center to realize instances of the application. The configuration of each component is a step handled by a different management system. There is no consistency in the configuration experience which forces each administrator to be a domain expert for that component.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments described herein are related to a method for a system manager to automatically provision computing resources based on events occurring in the computer network. The method may be performed in a computing network environment.

The system manager defines resource configurations for computing resources in the network computing environment. The resource configurations are associated with event conditions. The event conditions cause the system manager to apply the resource configurations to the computing resources.

The event conditions are also associated with various policies. The policies specify how the resource configurations are to be applied to the computing resources.

The occurrence of the event conditions is ascertained. In response, workflows are automatically executed. The workflows apply the resource configurations to the computing resources in accordance with the policies. This configures the computing resources according to the resource configurations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing system in which some embodiments described herein may be employed;

FIG. 2 illustrates a distributed computing system including multiple host computing systems in which some embodiments described herein may be employed;

FIG. 3 illustrates a host computing system that hosts multiple virtual machines and provides access to physical resources through a hypervisor;

FIGS. 4A-4D illustrate an example environment in which computing resources may be automatically provisioned based on events occurring in the computer network;

FIGS. 5A-5E, illustrate an example user interface that may be used by to generate a profile template;

FIG. 6 illustrates an example workflow that may be executed to automatically provision computing resources;

FIG. 7 illustrates a flowchart of an example method for a system manager to automatically provision computing resources based on events occurring in a computer network; and

FIG. 8 illustrates a flowchart of an example method for automatic end-to-end provisioning of computing resources in a computer network.

### DETAILED DESCRIPTION

Embodiments described herein disclose methods and systems related to automatically provisioning computing resources. One embodiment describes a method for a system manager to automatically provision computing resources based on events occurring in the computer network. The method may be performed in a computing network environment.

The system manager defines resource configurations for computing resources in the network computing environment. The resource configurations are associated with event conditions. The event conditions cause the system manager to apply the resource configurations to the computing resources.

The event conditions are also associated with various policies. The policies specify how the resource configurations are to be applied to the computing resources.

The occurrence of the event conditions is ascertained. In response, workflows are automatically executed. The workflows apply the resource configurations to the computing resources in accordance with the policies. This configures the computing resources according to the resource configurations.

Another embodiment describes a method for automatic end-to-end provisioning of computing resources. A determination is made that a computing resource has made a change to a data center service fabric. A first predefined profile template is accessed that includes a first resource configuration that configures the computing resource in a first manner. A first workflow is executed that automatically applies the first resource configuration to the computing resource to configure the computing resource in the first manner.

The computing resource is monitored for the occurrence of a predefined event condition that indicates a need to change the first resource configuration. In response to the occurrence of the predefined event condition, a second predefined profile template is accessed that includes a second resource configuration that configures the computing resource in a second manner. A second workflow is executed that automatically applies the second resource configuration to the computing resource to configure the computing resource in the second manner

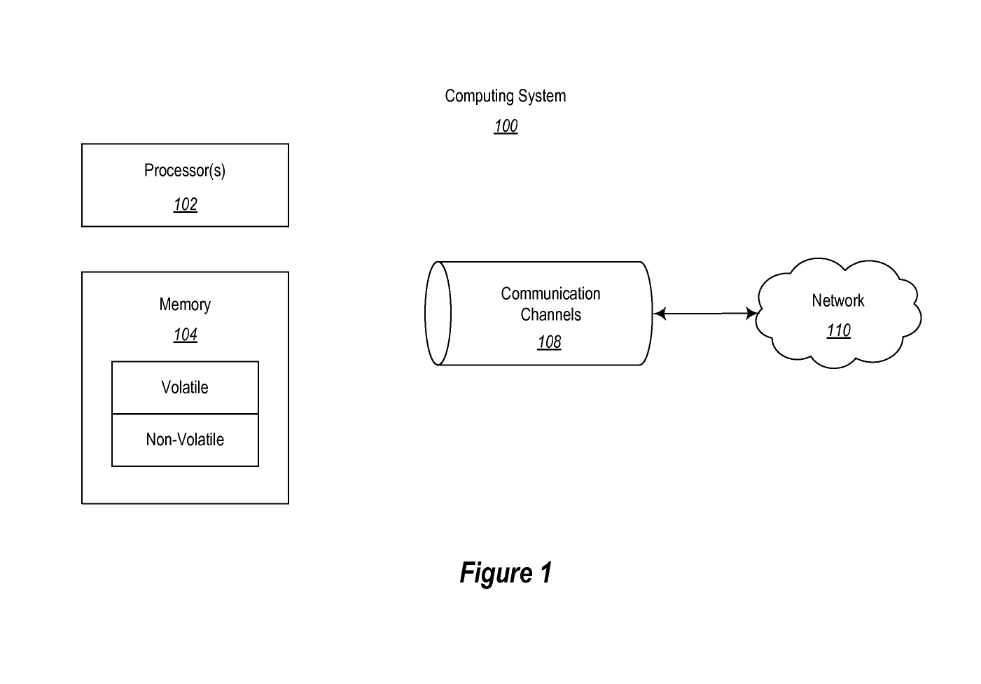

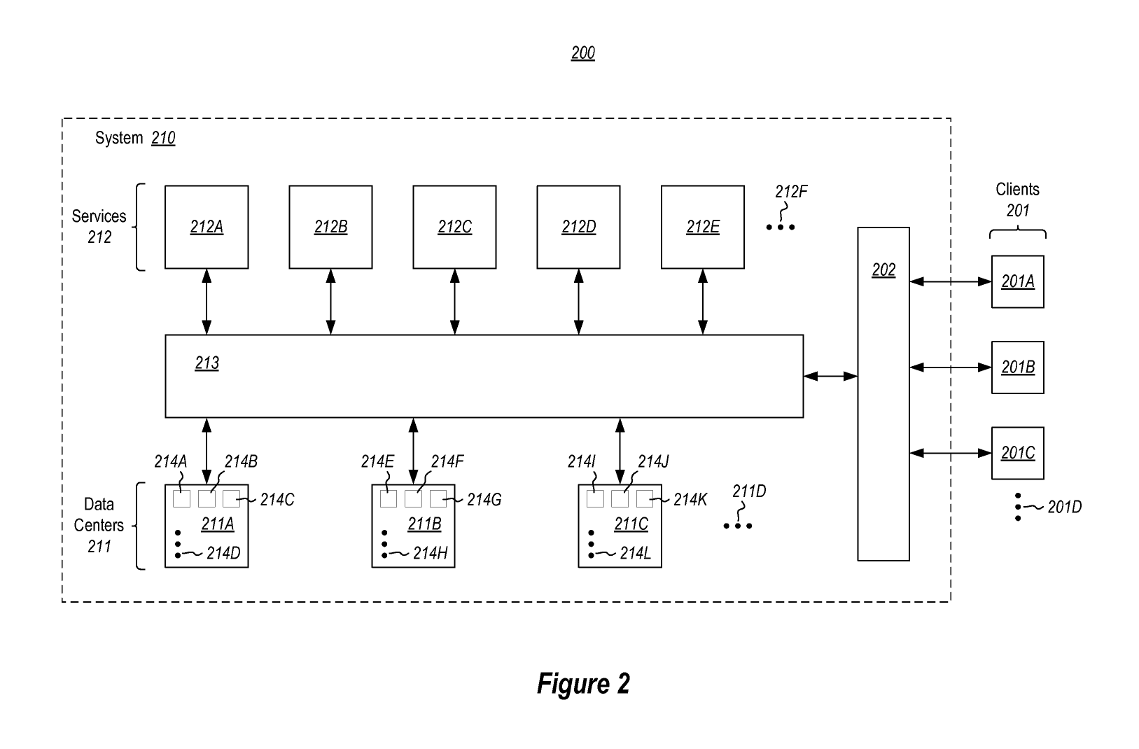

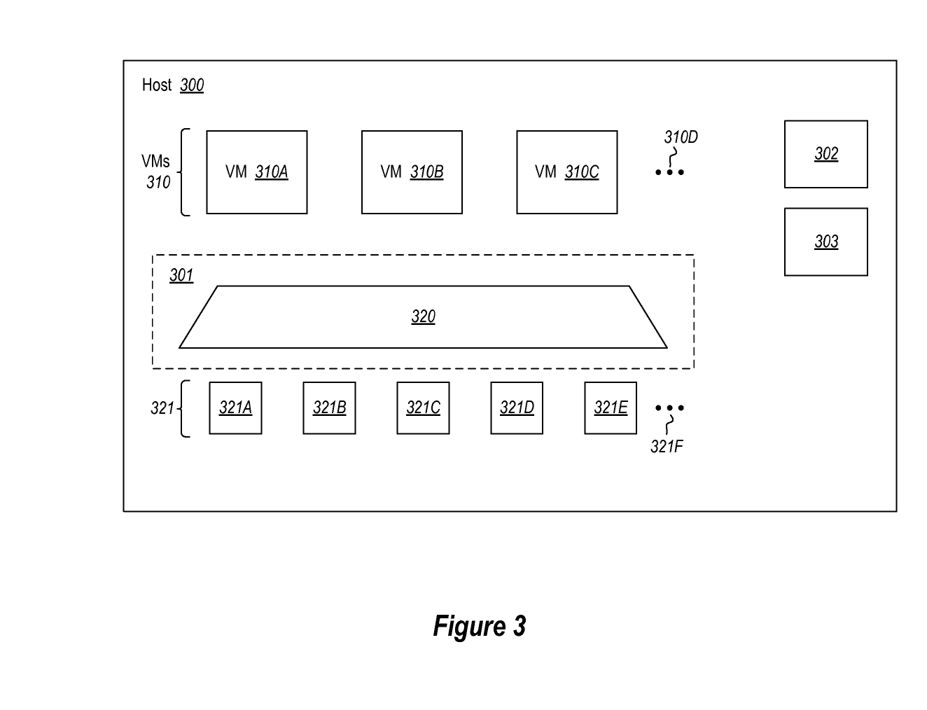

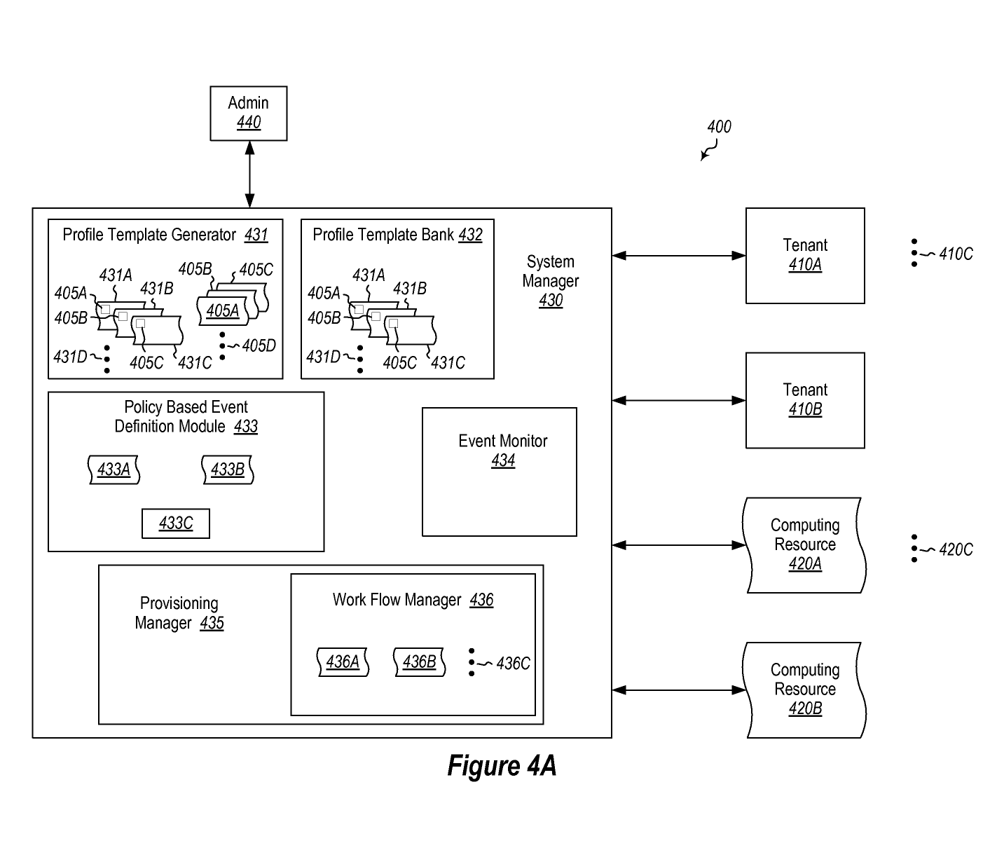

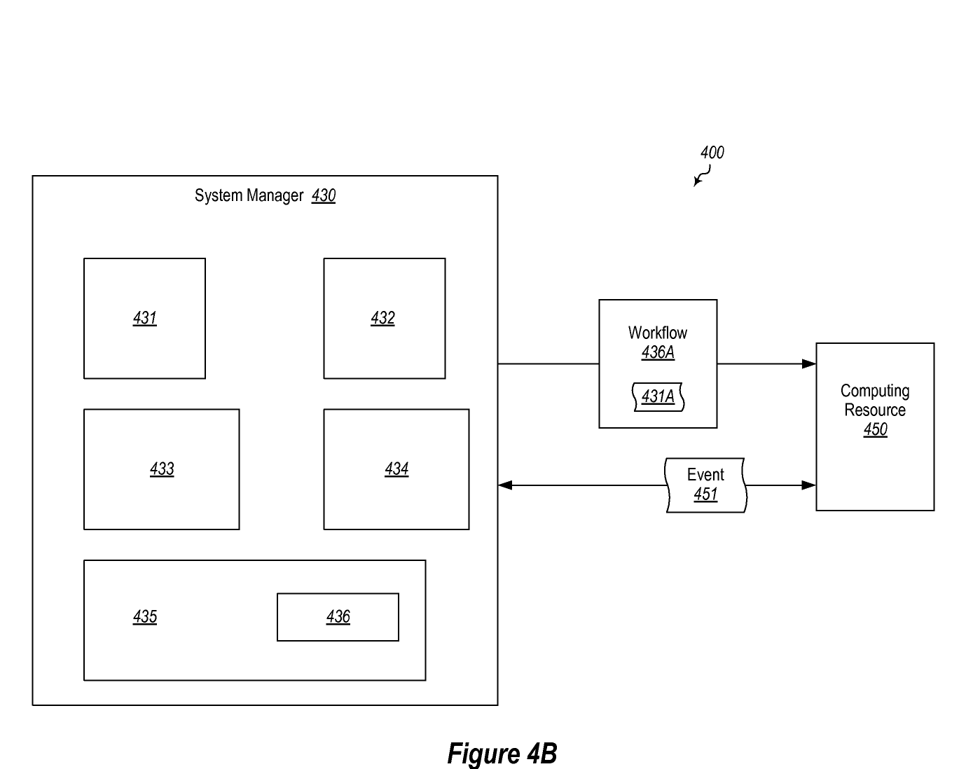

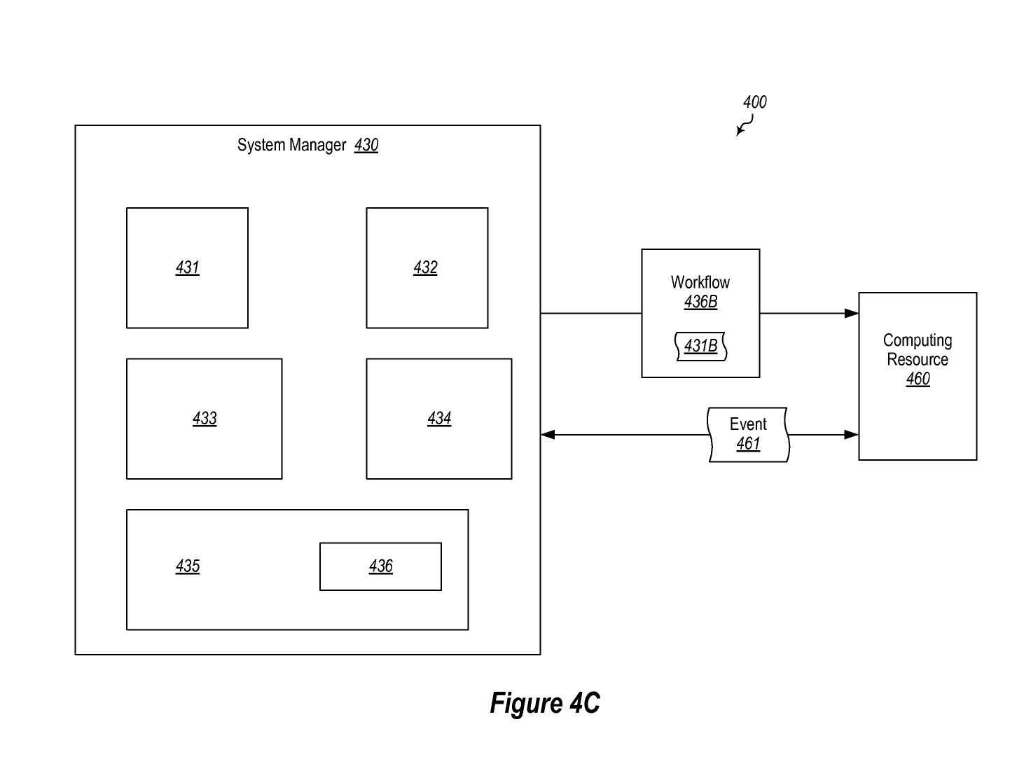

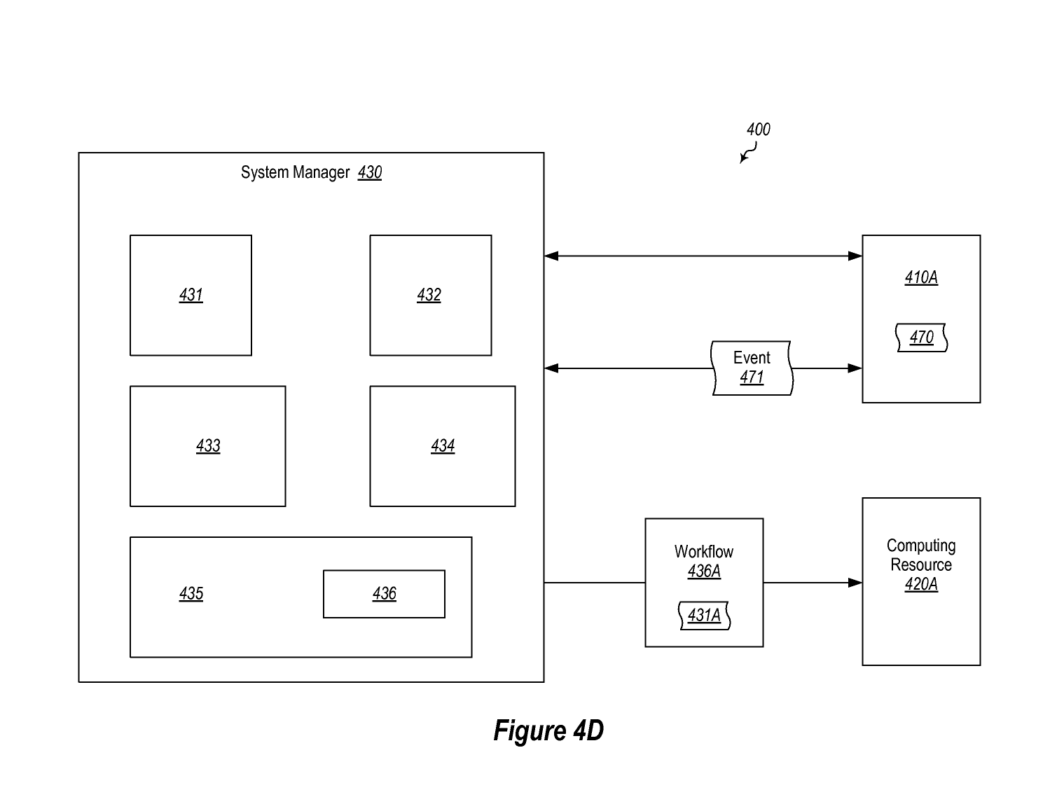

Some introductory discussion of a computing system will be described with respect to FIG. 1. The principles of a distributed computing system will be described with respect to FIG. 2. Then, the principles of operation of virtual machines will be described with respect to FIG. 3. Subsequently, the principles of automatically provisioning resources in response to changes in the system fabric will be described with respect to FIG. 4 and successive figures.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 abstractly illustrates an environment 200 in which the principles described herein may be employed. The environment 200 includes multiple clients 201 interacting with a system 210 using an interface 202. The environment 200 is illustrated as having three clients 201A, 201B and 201C, although the ellipses 201D represent that the principles described herein are not limited to the number of clients interfacing with the system 210 through the interface 202. The system 210 may provide services to the clients 201 on-demand and thus the number of clients 201 receiving services from the system 210 may vary over time.

Each client 201 may, for example, be structured as described above for the computing system 100 of FIG. 1. Alternatively or in addition, the client may be an application or other software module that interfaces with the system 210 through the interface 202. The interface 202 may be an application program interface that is defined in such a way that any computing system or software entity that is capable of using the application program interface may communicate with the system 210.

The system 210 may be a distributed system, although not required. In one embodiment, the system 210 is a cloud computing environment. Cloud computing environments may be distributed, although not required, and may even be distributed internationally and/or have components possessed across multiple organizations.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

The system 210 includes multiple data centers 211. Although the system 200 might include any number of data centers 211, there are three data centers 211A, 211B and 211C illustrated in FIG. 2, with the ellipses 211D representing that the principles described herein are not limited to the exact number of data centers that are within the system 210. There may be as few as one, with no upper limit. Furthermore, the number of data centers may be static, or might dynamically change over time as new data centers are added to the system 210, or as data centers are dropped from the system 210.

Each of the data centers 211 includes multiple hosts that provide corresponding computing resources such as processing, memory, storage, bandwidth, and so forth. The data centers 211 may also include physical infrastructure such as network switches, load balancers, storage arrays, and the like.

As illustrated in FIG. 2, the data center 211A includes hosts 214A, 214B, and 214C, the data center 211B includes hosts 214E, 214F, and 214G, and the data center 211C includes hosts 214I, 214J, and 214K, with the ellipses 214D, 214H, 214L representing that the principles described herein are not limited to an exact number of hosts 214. A large data center 211 will include hundreds or thousands of hosts 214, while smaller data centers will have a much smaller number of hosts 214. The number of hosts 214 included in a data center may be static, or might dynamically change over time as new hosts are added to a data center 211, or as hosts are removed from a data center 211. Each of the hosts 214 may be structured as described above for the computing system 100 of FIG. 1.

Each host is capable of running one or more, and potentially many, virtual machines. For instance, FIG. 3 abstractly illustrates a host 300 in further detail. As an example, the host 300 might represent any of the hosts 214 of FIG. 2. In the case of FIG. 3, the host 300 is illustrated as operating three virtual machines 310 including virtual machines 310A, 310B and 310C. However, the ellipses 310D once again represents that the principles described herein are not limited to the number of virtual machines running on the host 300. There may be as few as zero virtual machines running on the host with the only upper limit being defined by the physical capabilities of the host 300.

During operation, the virtual machines emulate a fully operational computing system including at least an operating system, and perhaps one or more other applications as well. Each virtual machine is assigned to a particular client or to a group of clients, and is responsible to support the desktop environment for that client or group of clients and is responsible to support the applications running on that client or group of clients.

The virtual machine generates a desktop image or other rendering instructions that represent a current state of the desktop, and then transmits the image or instructions to the client for rendering of the desktop. For instance, referring to FIGS. 2 and 3, suppose that the host 300 of FIG. 3 represents the host 214A of FIG. 2, and that the virtual machine 310A is assigned to client 201A (referred to herein as “the primary example”), the virtual machine 310A might generate the desktop image or instructions and dispatch such instructions to the corresponding client 201A from the host 214A via a service coordination system 213 and via the system interface 202.

As the user interacts with the desktop at the client, the user inputs are transmitted from the client to the virtual machine. For instance, in the primary example and referring to FIGS. 2 and 3, the user of the client 201A interacts with the desktop, and the user inputs are transmitted from the client 201 to the virtual machine 310A via the interface 201, via the service coordination system 213 and via the host 214A.

The virtual machine processes the user inputs and, if appropriate, changes the desktop state. If such change in desktop state is to cause a change in the rendered desktop, then the virtual machine alters the image or rendering instructions, if appropriate, and transmits the altered image or rendered instructions to the client computing system for appropriate rendering. From the prospective of the user, it is as though the client computing system is itself performing the desktop processing.

The host 300 includes a hypervisor 320 that emulates virtual resources for the virtual machines 310 using physical resources 321 that are abstracted from view of the virtual machines 310. The hypervisor 320 also provides proper isolation between the virtual machines 310. Thus, from the perspective of any given virtual machine, the hypervisor 320 provides the illusion that the virtual machine is interfacing with a physical resource, even though the virtual machine only interfaces with the appearance (e.g., a virtual resource) of a physical resource, and not with a physical resource directly. In FIG. 3, the physical resources 321 are abstractly represented as including resources 321A through 321E, and potentially any number of additional physical resources as illustrated by the ellipses 321F. Examples of physical resources 321 including processing capacity, memory, disk space, network bandwidth, media drives, and so forth.

The host 300 may operate a host agent 302 that monitors the performance of the host, and performs other operations that manage the host. Furthermore, the host 300 may include other components 303.

Referring back to FIG. 2, the system 200 also includes services 212. In the illustrated example, the services 212 include five distinct services 212A, 212B, 212C, 212D and 212E, although the ellipses 212F represent that the principles described herein are not limited to the number of services in the system 200. A service coordination system 213 communicates with the hosts 214 and with the services 212 to thereby provide services requested by the clients 201, and other services (such as authentication, billing, and so forth) that may be prerequisites for the requested service.

Attention is now given to FIG. 4A, which illustrates a data center 400. The data center 400 may correspond to the data centers 211 previously discussed. As illustrated, the data center 400 includes tenants 410A and 410B (hereinafter also referred to as “tenants 410”), with the ellipses 410C indicating that there may be any number of additional tenants. Each tenant 410 represents an entity (or group of entities) that use or have allocated to their use a portion of the computing resources of the data center 400. The allocated computing resources are used to perform applications and other tasks for each tenant. In one embodiment, each of the tenants 410 may have access to one or more virtual machines that are distributed across multiple hosts in the manner previously described in relation to FIGS. 2 and 3.

The data center 400 also includes computing resources 420A and 420B (hereinafter also referred to as “computing resources 420”), with the ellipses 420C indicating that there may be any number of additional computing resources. The computing resources 420 represent all the physical and virtual computing resources of the data center 400 and may correspond to the hosts 214. Examples include servers or hosts, network switches, processors, storage arrays and other storage devices, software components, and virtual machines. The computing resources 420 may be distributed across the multiple hosts 214 in the manner previously described in relation to FIGS. 2 and 3. The computing resources may also include applications running in the data center 400.

The data center 400 further includes a system manager 430. In one embodiment, the system manager 430 manages the interaction between the tenants 410 and the computing resources 420. The system manager 430 may be implemented in a distributed manner in multiple hosts 214 or it may be implemented on a single host. It will be appreciated that the system manager 430 has access to various processing, storage, and other computing resources of the data center 400 as needed. The operation of the system manager 430 will be explained in more detail to follow. It will also be appreciated that the various components and modules of the system manager 430 that will be descried may also be distributed across multiple hosts 214. Further the system manager 430 may include more or less than the components and modules illustrated and the components and modules may be combined as circumstances warrant.

FIG. 4A illustrates an administrator 440 that is able to access and configure the system manager 430. The administrator 440 may be associated with the owner or operator of the data center 400. Alternatively, the administrator 440 may be associated with one of the tenants 410 being hosted by the data center 400. In some embodiments, there may be more than one administrator 440 who may be associated with the same entity or different entities. Accordingly, the illustrated administer 440 and the discussion of the administrator 440 herein represents all possible administrators.

The system manager 430 includes a profile template generator 431 and an associated profile template bank 432. The profile generator allows the administrator 440 to predefine resource configurations 405A, 405B, 405C, and potentially any number of additional resource configurations as illustrated by the ellipses 405D (hereinafter also referred to simple as “resource configurations 405”) for computing resources 420 that will be added to the data center 400 or that will be reconfigured in some manner. The profile template generator 431 will then generate profile templates 431A, 431B, 431C, and potentially any number of additional profile templates as illustrated by the ellipses 431D that includes one or more of predefined resource configurations 405.

In some embodiments, the resource configurations 405 may also be configuration settings that are suggested by the system manager 430 or some other element of the data center 400. In this manner, the system manager is able to suggest configuration settings that may be useful for a given instance of computing resources 420 being added to the data center 400 or being reconfigured. In addition, in some embodiments the system manager 420 is able to add configuration settings to the resource configurations 405 that are outside of the configuration setting defined by the administrator 440. This allows the system manager to add configuration settings that may be useful for a given instance of computing resources 420 being added to the data center 400 or being reconfigured.

The profile templates, for example the profile template 431A, are then used by the system manager 430 to automatically configure the relevant computing resources according to the predefined resource configurations 405 included in the profile template 431A as will be explained in more detail to follow. It will be appreciated that profile template 431A, or any of the profile templates, need only be generated once and may then be used over and over for as long as the predefined resource configurations 405 included in the profile template are still valid. That is, once the profile template 431A is generated, it is stored in the profile template bank 432 and may be used to configure numerous instances of the computing resources 420 associated with the profile template 431A.

For example, for a host or server, a predefined resource configuration 405A may include operating system image and customization information, application packages and customization information, IP addresses, MAC addresses, world-wide names, and hardware prerequisites for storage, networking, and computing. It will be appreciated that the predefined resource configuration 405A may include additional or different resource configurations.

As illustrated, the profile template generator 431 generates the profile template 431A and includes the predefined resource configuration 405A in the profile template. The profile template 431A is then stored in the profile template bank 432. As illustrated, the profile bank 432 also stores profile templates 431B and 431C. These profile templates may include other predefined resource configurations 405B and 405C that may be different from the predefined resource configuration 405A of profile template 431A and may be different from each other. The ellipses 431D indicate that any number of profile templates may be stored in the profile template bank 432.

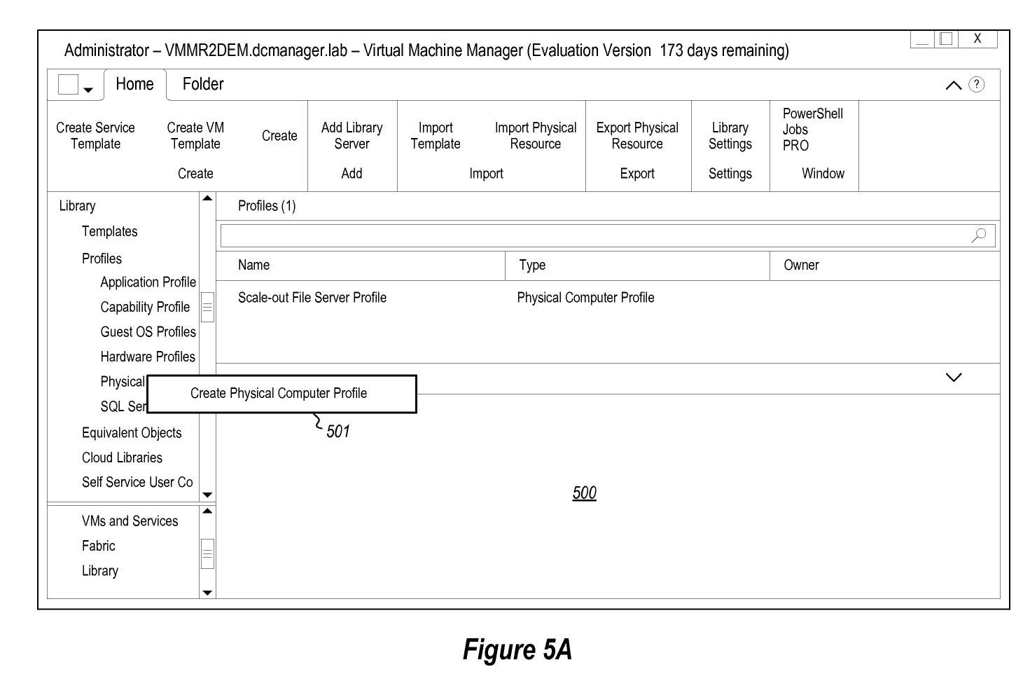

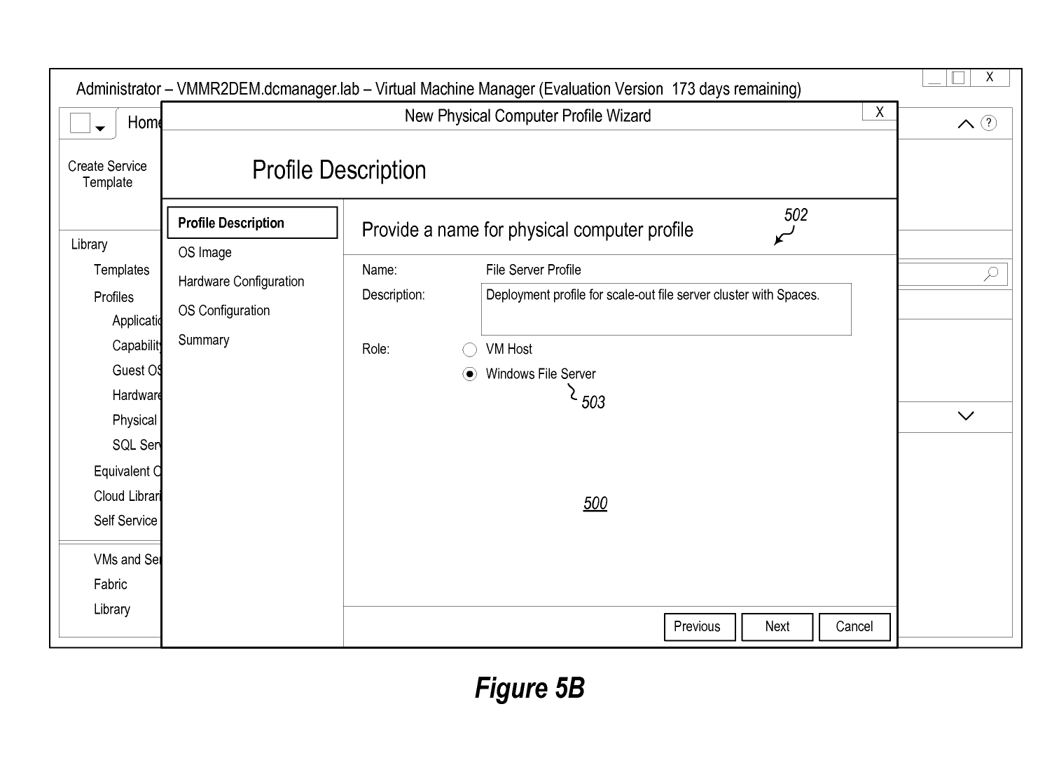

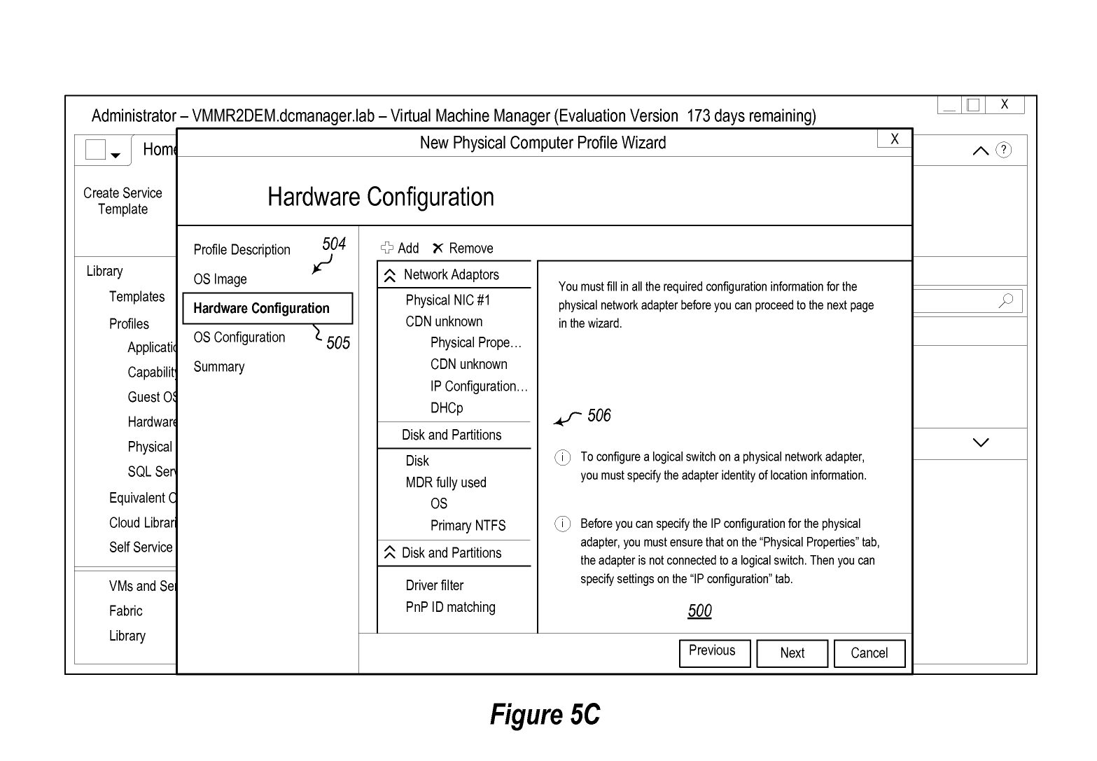

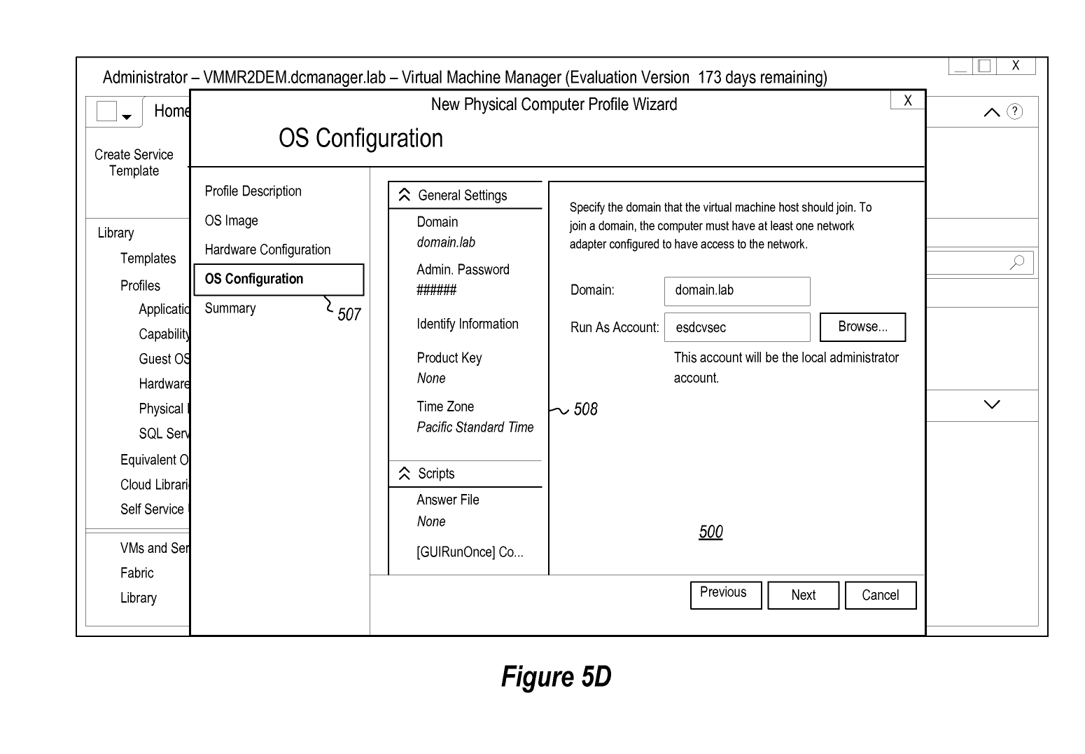

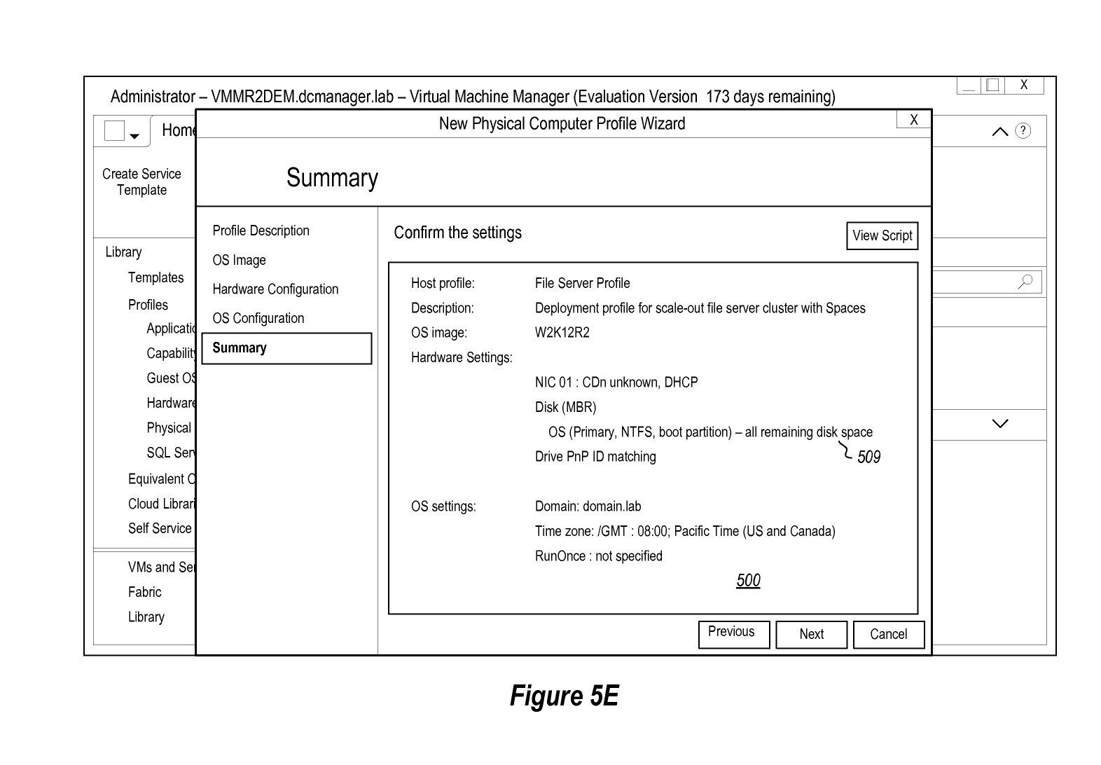

Attention is now turned to FIGS. 5A-5E, which shows an example user interface 500 that may be used by the administrator 440 to cause the system manager 430 to generate a profile template such as the profile template 431A. It will be appreciated that profiles may also be programmatically generated via software APIs. As shown in FIG. 5A, a user interface element 501 is selected to create a new template 431A for a physical computer. It will be appreciated that FIGS. 5A-5E do not necessarily show every step in the resource configuration selection process or the profile template generation process.

FIG. 5B illustrates input elements 502 that allow the administrator 440 to select a name for the profile template 431A and to provide a description of the template. A user interface element 503 may be used to define the role of the physical computer.

FIG. 5C illustrates at 504 that various predefined resource configurations 405 may be selected for the physical computer. FIG. 5C shows at 505 that a hardware configuration has been selected. The user interface shows at 506 various resource configurations related to hardware that may be selected by the associated user interface elements.

FIG. 5D illustrates at 507 that an OS configuration has been selected. The user interface shows at 508 various resource configurations related to the operating system that may be selected by the associated user interface elements.

FIG. 5E illustrates in the user interface 500 at 509 a summary of the selected resource configurations 405 for the physical computer. The profile template generator 431 will use the selected resource configurations 405, for example resource configuration 405A, to generate the profile template 431A.

Returning to FIG. 4, the system manager 430 includes a policy based event definition module 433. In operation, the policy based event definition module 433 allows the administrator 440 to define various event conditions 433A that will enable the computing resources of the data center 400 to generate events that may require the system manager 430 to perform an action such as applying the resource configurations 405 of the templates 431A, 431B, and 431C to the computing resources to remediate the condition causing the event. Examples of event conditions 433A may include, but are not limited to, receiving a DHCP request from a new sever that has been added to the computing resources 420, on demand capacity expansion based on resource exhaustion (re-active) or forecasted increase in resource utilization (pre-emptive), scale-in of resources based on over allocation of capacity, and re-provisioning of failed components. It will be appreciated that the event conditions 433A need not only be a single event, but may also be a sequence of multiple events.

In addition to defining the event conditions 433A that may cause the generation of the events, the policy based event definition module 433 also is configured to allow the administrator 440 to define various policies 433B for the event conditions 433A that indicate how or the manner in which the resource configurations 405 are to be applied. For example, one policy 433B may specify that when the system manager 430 receives a DHCP request from a new sever, which is an example of an event condition 433A, the system manager 430 should determine if the server is made by a particular server vendor such as IBM or Dell. If the server is from the particular vendor, then the system manager 430 will react to the event condition in a manner that is different from the how the system manager will react if the server is not from the particular vendor. For instance, the server may be provisioned with the resource configuration 405A of the profile template 431A if the server is from the particular vendor and provisioned with resource configuration 405B of the profile template 431B if the server is not from the particular vendor.

Another example of a policy 433B may be that for a newly added server assigned a certain IP subnet, specific resource configurations 405 for the server are provisioned. A policy 433B may specify that for a group of newly added servers, a first subset will be configured with the resource configuration 405A and a second subset will be configured with the resource configuration 405B. It will be appreciated that there may be any number of additional policies 433B defined by the administrator 440 as circumstances warrant. In addition, more than one defined policy 433B may be applied to the event conditions 433A. Accordingly, the policies 433B give the administrator 440 the ability define how the system manager 430 will apply the resource configurations in response to the event conditions 433A in accordance with the infrastructure and environment being managed by the administrator and the applications running on that infrastructure.

The policy based event definition module 433 includes a map table 433C that maps the administrator 440 defined policies 433B to the various event conditions 433A. In this way, the system manager 430 is able to apply the proper policy 433B to an event condition 433A.

The system manager 430 also includes an event monitor 434. In operation the event monitor 434 is configured to monitor the tenants 410 and the computing resources 420 for the event conditions 433A that may cause the system manager 430 to take some action. The event monitor 434 may monitor or otherwise analyze performance counters and event logs of the computing resources 420 to determine if the event condition has occurred. In one embodiment, the event monitor 434 may be a provider that is installed so that the system manager 430 may communicate with the computing resources 420 that are being monitored. In other embodiments, a computing resource 420 or a tenant 410 may notify the event monitor 434 in an unsolicited fashion that an event condition 433A has occurred, without the need for the event monitor 434 to directly monitor the computing resources. Accordingly, any discussion herein of the event monitor 434 directly monitoring is also meant to cover the embodiments where the event monitor is notified of an event condition.

In another embodiment, the event monitor 434 may be part of or associated with an operations manager that provides management packs that specify the types of monitoring that will occur for a specific computing resource 420. For example, the management packs may define their own discovery, monitoring, and alerting models that are to be used to determine if the event condition has occurred.

In some instances, the management packs may be defined by the administrator 440 and may be included as part of a defined policy 433B. This allows the administrator 440 to define the types of end-to-end monitoring of the computing resources 420 that will occur as the computing resource becomes active in the data center 400 and as it continues to operate in the data center 400. In other words, this allows the administrator 440 to define the most desirable types of monitoring for the entire lifecycle of the computing resources 420 he or she administers.

The system manager 430 also includes a provisioning manager 435. In operation, the provisioning manager 435 associates one or more of the profile templates 431A, 431B, or 431C with a specific event condition 433A and its associated policy 433B. This allows the provisioning manager 435 to know which profile template to automatically apply to a target computing resource 420 when the event condition 433A indicates that an action should be taken by the system manager 430. In addition, this ensures that any profile template complies with any policy 433B that is associated with the event condition.

For example, in one embodiment system manager 430 may receive or the event monitor 434 may discover a DHCP request from an unmanaged baseboard management controller that the fabric of the data center 400 requires a new operating system using bare metal deployment. In response, the provisioning manager 435 will associate the proper profile template 431A, 431B, or 431C with this event and any associated policies. The event itself may indicate the target computing resource or the profile template 431A, 431B, or 431C may indicate the target computing resource

The provisioning manager 435 also includes a workflow manager 436. In operation, after capturing the event condition 433A and finding the appropriate profile template 431A, 431B, or 431C for that event condition 433A and any associated profiles 433B, the workflow manager 436 automatically executes workflows 436A, 436B, and potentially any number of additional workflows as illustrated by ellipses 436C that apply the resource configurations 405 specified in the profile template to the target resource. The workflow manager 436 is responsible for orchestrating all the necessary changes to the underlying data center fabric and managed devices. In this way, the system manager 430 is able to ensure that the applied resource configurations 405 are sufficient for the requirements of the applications running in the data center. It will be appreciated that more than one workflow may be executed by the workflow manager 436 to apply the resource configurations 405 specified in the profile template to the target resource.

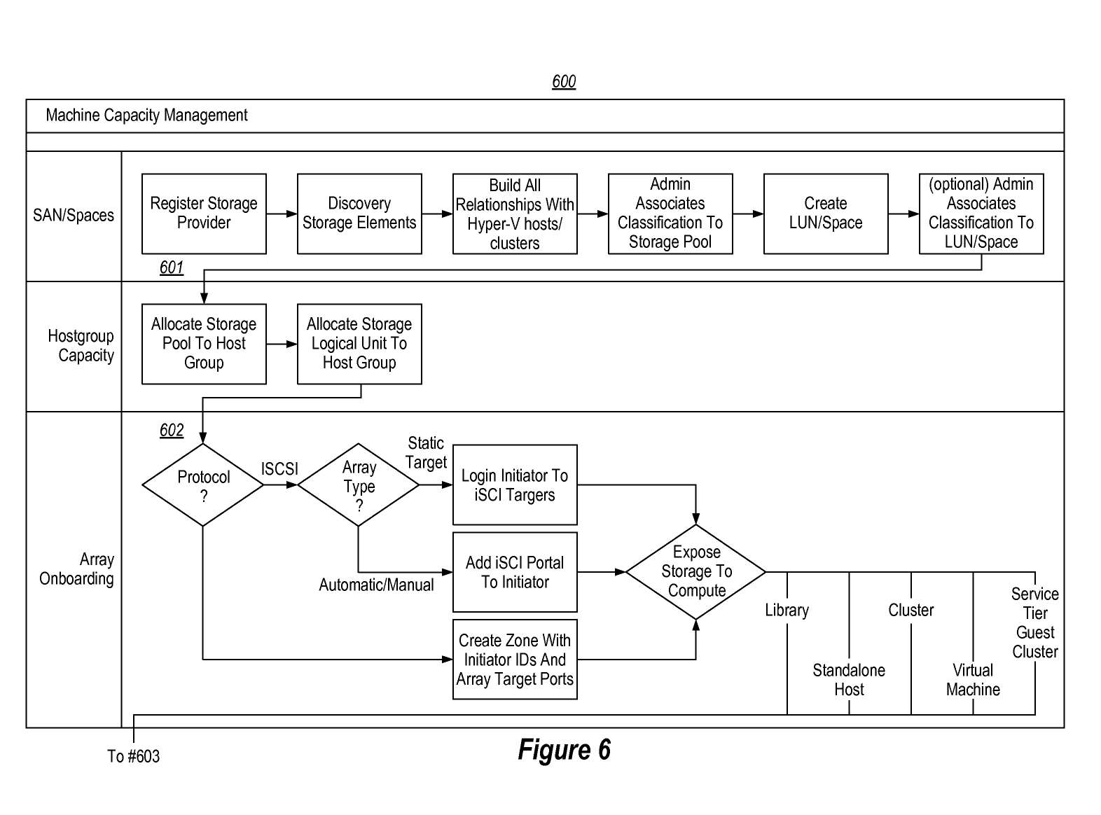

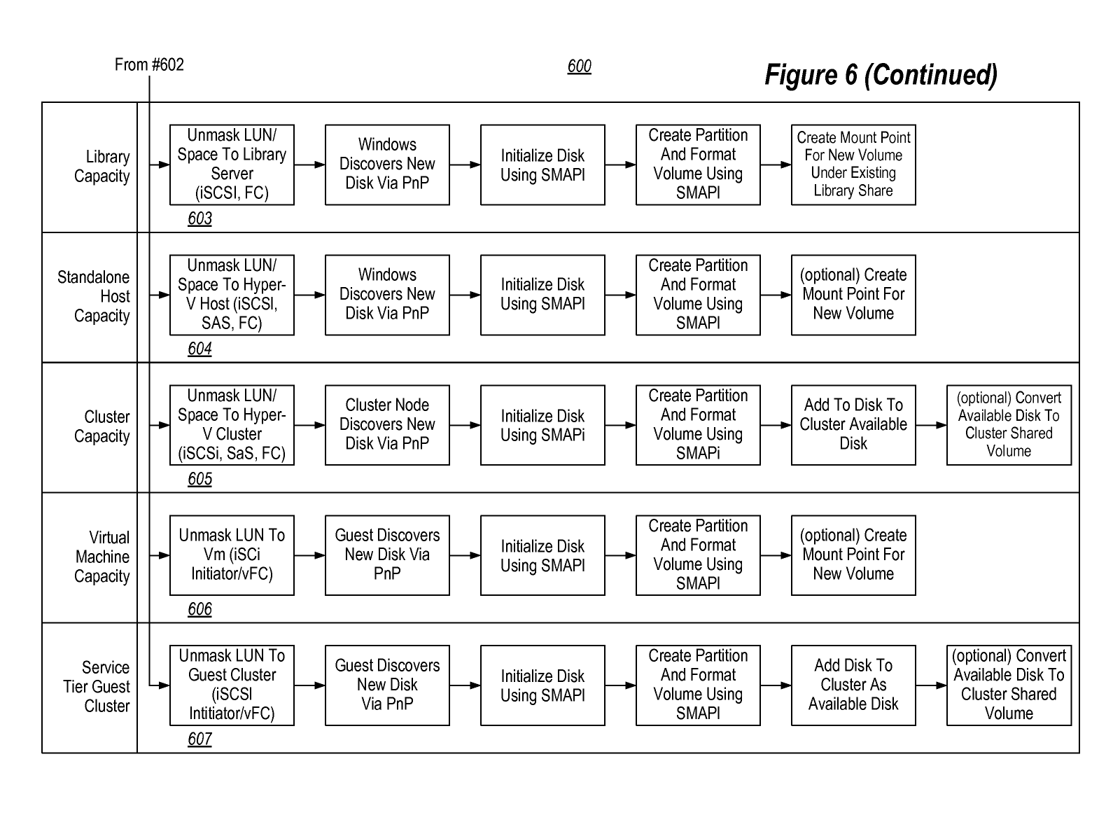

FIG. 6 illustrates an example workflow 600 that may correspond to the workflows 436A, 436B, or 436C and that may be executed by the workflow manager 436. The workflow of FIG. 6 is a workflow for adding storage capacity to a host, either physical or virtual, or to a cluster of hosts. As illustrated, the workflow of FIG. 6 discovers and creates new storage space or LUN and allocates the storage to the host group at 601. At 602, the storage space is exposed to the host or to the cluster. As shown in 602, depending on the type of storage protocol, for example iSCSI or Fibre Channel, different tasks are performed. The workflow further shows at 603-607 the tasks that are performed after exposing specific types of storage capacity to the host.

Having described the elements of the data center 400 and specifically the system manager 430, specific embodiments of the operation of the system manager 430 and its components will now be explained. Attention is first given to FIG. 4B, which illustrates an alternative view of the data center 400. It will be appreciated that for ease of explanation, FIG. 4B does not include all the elements of FIG. 4A. FIG. 4B illustrates an embodiment of when a computing resource 450 such as a new server is placed in the data center fabric. It will be appreciated the computing resource 450 may be an example of the computing resources 420 previously described.

As shown, the addition of the computing resource 450 is a condition that causes an event 451, which may be an example of an event 433A, to be generated by the computing resource 450. In the embodiment, the event 451 may be a DHCP request from the computing resource 450 indicating the need for a bare metal deployment of the computing resource 450. The event 451 may be sent by the computing resources 450 or it may be monitored by the event monitor 434.

When the event 451 is received or accessed by the system manager 430, the provisioning manager 435 determines which of the predefined profile templates 431A, 431B, or 431C includes the appropriate resource configurations 405 to remediate the condition that caused the event 451. As previously described, this determination is based on the mapping between the event condition 433A and the profiles 433B specified in the map table 433C. Accordingly, in the illustrated embodiment the profile template 431A that includes the resource configuration 405A is selected.

Once the appropriate predefined profile template 431A has been selected, the workflow manager 436 begins to execute the necessary workflow, which in this embodiment is the workflow 436A, that automatically applies the resource configuration 405A of the profile template 431A to the computing resources 450. This results in the computing resource 450 being provisioned as specified by the predefined template 431A and the resource configuration 405A.

FIG. 4C illustrates an alternative view of the data center 400. It will be appreciated that for ease of explanation, FIG. 4C does not include all the elements of FIG. 4A. FIG. 4C illustrates an embodiment where a computing resource 460 may be a storage device or storage cluster that is already operating in the fabric of the data center 400. It will be appreciated the computing resource 460 may be an example of the computing resources 420 previously described.

During operation, a condition may arise where the computing resource 460 is not able to satisfy the capacity demands of a thinly provisioned storage volume. Accordingly, an event 461, which may be an example of an event 433A, will be generated because of this condition. The event 461 may be sent by the computing resources 460 or it may be monitored by the event monitor 434.

When the event 461 is received or accessed by the system manager 430, the provisioning manager 435 determines which of the predefined profile templates 431A, 431B, or 431C includes the appropriate resource configurations 405 to remediate the condition that caused the event 461, which in the illustrated embodiment may be provisioning additional storage resources. As previously described, this determination is based on the mapping between the event condition 433A and the profiles 433B specified in the map table 433C. Accordingly, in the illustrated embodiment the profile template 431B that includes the resource configuration 405B is selected.

Once the appropriate predefined profile template 431B has been selected, the workflow manager 436 begins to execute the necessary workflow, which in this embodiment is the workflow 436B, that automatically applies the resource configuration 405B of the profile template 431B to the computing resources 460. This results in the computing resource 460 being provisioned as specified by the predefined template 431B and the resource configuration 405B.

The embodiment illustrated in FIG. 4C is an example of an on demand capacity expansion based on resource exhaustion and is therefore re-active to conditions in the fabric of the data center 400. The embodiments disclosed herein, however, are also applicable to pre-emptive changes to the server fabric. For example, the system manager 430 is able to forecast or predict an increase in resource utilization in the data center 400 and is able to automatically provision increased resources such as computing or storage resources using the predefined profile templates previously described to meet the predicted increase in resource utilization.

In an alternative embodiment, a condition may arise where the computing resource 460 has failed. This failure condition will generate the event 461. The system manager 430 will automatically rebuild the failed computing resource by accessing and then applying the appropriate profile template and workflow in the manner previously described. In this way, the embodiments disclosed herein provide for the automatic rebuild of failed resources in the data center 400.

The embodiments illustrated in FIGS. 4B and 4C were primarily driven by changes to the infrastructure of data center 400. The embodiments disclosed herein may also be driven by applications that are run by the tenants 410 in the data center 400. For example, FIG. 4D illustrates an alternative view of the data center 400. It will be appreciated that for ease of explanation, FIG. 4D does not include all the elements of FIG. 4A. FIG. 4D illustrates an embodiment where the tenant 410A is running an application 470 across the computing resources of the data center 400.

In some embodiments, the event monitor 434 may monitor a poor performance of the application 470. Alternatively, the application 470 or other resources of the tenant 410A may recognize the poor performance. This condition will cause the generation of an event 471, which may be an example of an event 433A, and which may specify that additional computing resources should be added to the data center fabric to support the application 470.

When the event 471 is received or accessed by the system manager 430, the provisioning manager 435 determines which of the predefined profile templates 431A, 431B, or 431C includes the appropriate resource configurations 405 to remediate the condition that caused the event 471, which is this embodiment may be provisioning additional computing and/or storage resources so that the application 470 may function properly. The provisioning of the additional computing resources may include the bare metal deployment of new servers or the reallocation of existing computing resources. In any case, the proper profile template will be determined based on the needed remedial action. As previously described, this determination is based on the mapping between the event condition 433A and the profiles 433B specified in the map table 433C. Accordingly, in the illustrated embodiment the profile template 431A that includes the resource configuration 405A is selected.

Once the appropriate predefined profile template 431A has been selected, the workflow manager 436 begins to execute the necessary workflow, which in this embodiment is the workflow 436A, automatically applies the resource configuration 405A of the profile template 431A. In the embodiment of FIG. 4D, the profile template 431A and workflow 436A are applied to the computing resources 420A. This results in the computing resources 420A being provisioned as specified by the predefined template 431A. Accordingly, the data center 400 is provided with enough computing resources to properly run the application 470.

In an alternative embodiment, the application 470 may drive the provisioning of the data center 400 from end-to-end. In such embodiments, the application 470 may dictate the resource configurations 405 that should be included in a profile template 431A, 431B, or 431C so that enough computing resources are provisioned in the data center 400 to run the application 470 properly. When the application 470 is run, the system manager 430 receives the event indicating the application is being run and then accesses the appropriate profile template in the manner described. The system manager 430 then executes the appropriate workflow that will apply the resource configurations of the profile template to the computing resources.

Accordingly, the embodiments disclosed herein ensure that the resource configurations of the data center 400 satisfy the requirements of the applications running in the data center. If the resource configurations will not satisfy the requirements of the applications, the system manager 430 is able to use the predefined profile templates to automatically make changes to the computing resources of the data center 400 to ensure that there is sufficient provisioning of resources to meet the needs of the applications. This ensures that applications do not run out of storage capacity by enabling duplication and reclaiming of storage space and ensures that applications do not run out of compute capacity by scaling out the service to balance demand. In addition, it ensures that clusters running an application acquire additional resources by provisioning newly available servers. Further, this ensures that virtual machines running applications do not experience interruption in service by automatically migrating workloads to capacity provisioned by the service manager 430.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

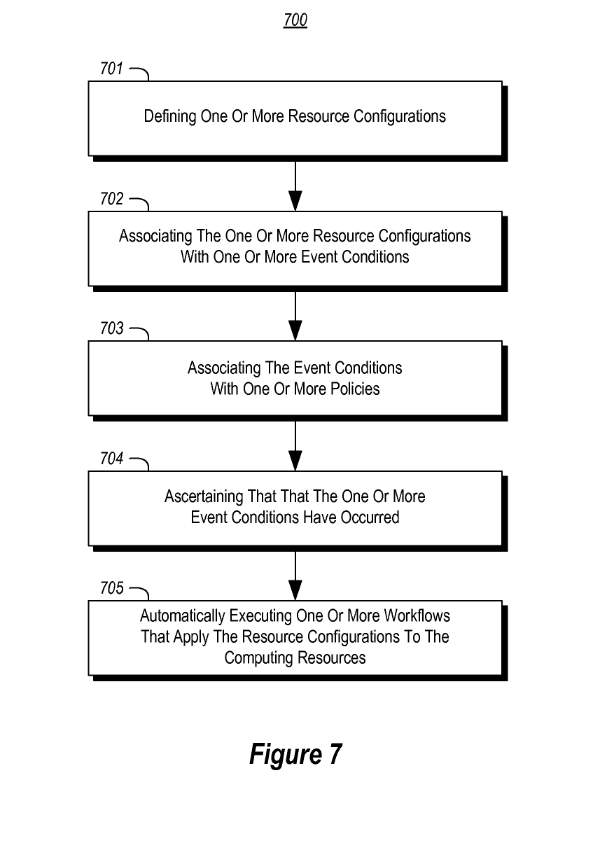

FIG. 7 illustrates an example method 700 for a system manager to automatically provision computing resources based on events occurring in a computer network. The method 700 will be described in relation to FIGS. 1-4 described above.

The method 700 includes an act of defining at a system manager one or more resource configurations for computing resources in a network computing environment (act 701). For example, the profile template generator 431 of the system manager 430 allows the administrator 440 to define resource configurations 405 that are suitable to configure the computing resources 420 in a specified manner as previously described. In some embodiments as previously described, the resource configurations 405A, 405B, and 405C are associated with a profile template 431A, 431B, and 431C.

The method 700 includes an act of associating the one or more resource configurations with one or more event conditions that cause the system manager to apply the one or more resource configurations to the computing resources (act 702). For example, the policy based event definition module 433 allows the administrator 440 to define event conditions 433A that will cause the computing resources of the data center 400 to generate events that may require the system manager 430 to perform an action such as applying the resource configurations 405A, 405B, and 405C of the templates 431A, 431B, and 431C to the computing resources to remediate the condition causing the event. The provisioning manager 435 may associate the resource configurations 405 with a specified event condition that the resource configurations 405 may remedy.

The method 700 includes an act of associating the event conditions with one or more policies that specify how the one or more resource configurations are to be applied to the computing resources (act 703). For example, the policy based event definition module 433 also is configured to allow the administrator 440 to define various policies 433B for the event conditions 433A that indicate how or the manner in which the resource configurations 405 are to be applied.

The method 700 includes an act of ascertaining that that the one or more event conditions have occurred (act 704). For example, the system manager 430 includes the event monitor 434 that is configured to ascertain when the event conditions 433A in the manner previously described.

The method 700 includes an act of, in response to ascertaining that the one or more event conditions have occurred, automatically executing one or more workflows that apply the resource configurations to the computing resources in accordance with the one or more policies to thereby configure the specified computing resources according the applied resource configurations (act 705). For example the workflow manager 436 of the provisioning manager 435 may execute a workflow 436A, 436B, or 436C that applies the resource configurations 405 to the target computing resource to thereby cause the computing resource in the manner specified by the resource configurations.

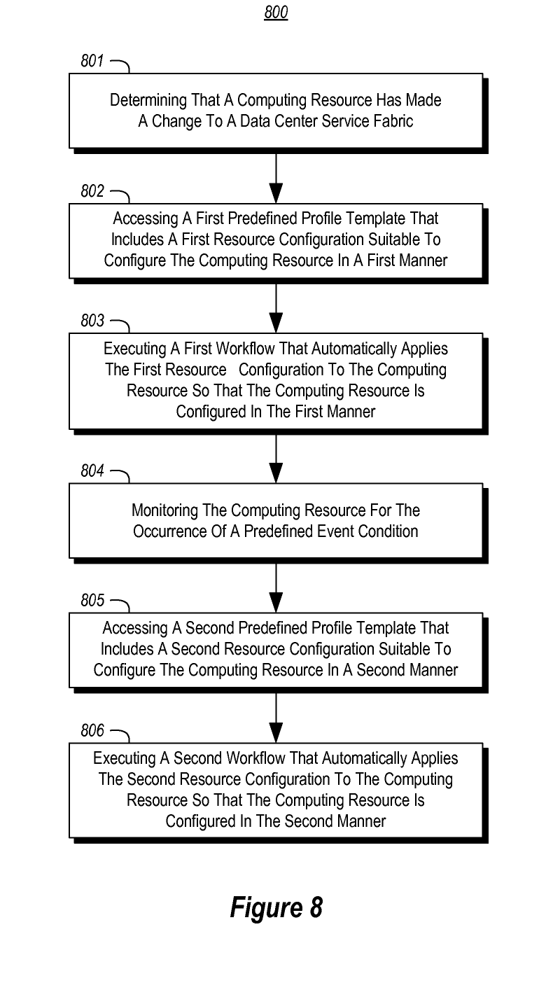

FIG. 8 illustrates an example method 800 for automatic end-to-end provisioning of computing resources in a computer network. The method 800 will be described in relation to FIGS. 1-4 described above.

The method 800 includes an act of determining that a computing resource has made a change to a data center service fabric (act 801). For example, the system manager 430, especially the event monitor 434, may determine that a change has occurred. In some embodiments, this may include receiving a request from new infrastructure placed in the service fabric or it may be receiving information from an application running in the data center 400.

The method 800 include an act of accessing a first predefined profile template that includes a first resource configuration suitable to configure the computing resource in a first manner (act 802). For example, the system manager 430 is able to access the profile template 431A that includes a first resource configuration 405A that, when implemented on a computing resource 420, configure the resource in the first manner.

The method 800 includes an act of executing a first workflow that automatically applies the first resource configuration to the computing resource so that the computing resource is configured in the first manner (act 803). For example, the workflow manager 436 automatically executes a workflow 436A that applies the profile template 431A and it resource configuration 405A to a computing resource 420 to configure the computing resource in the first manner. As previously described, policies 433B may determine how the profile template 431A is applied.

The method 800 includes an act of monitoring the computing resource for the occurrence of a predefined event condition that indicates that a change in the first resource configuration is needed (act 804). For example, the event monitor 434 may monitor the occurrence of an event condition 433A in the manner previously described.

The method 800 includes an act of, in response to the occurrence of the predefined event condition, accessing a second predefined profile template that includes a second resource configuration suitable to configure the computing resource in a second manner (act 805). For example, the system manager 430 is able to access the profile template 431B that includes a second resource configuration 405B that, when implemented on the computing resource 420, configure the resource in the second manner.

The method 800 includes an act of executing a second workflow that automatically applies the second resource configuration to the computing resource so that the computing resource is configured in the second manner (act 806). For example, the workflow manager 436 automatically executes a workflow 436B that applies the profile template 431B and it resource configuration 405B to the computing resource 420 to configure the computing resource in the second manner. As previously described, policies 433B may determine how the profile template 431B is applied.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a network computing environment, a method for a system manager to automatically provision computing resources based on events occurring in the computer network, the method comprising:
an act of defining at a system manager one or more resource configurations for computing resources in the network computing environment;
an act of associating the one or more resource configurations with one or more event conditions that cause the system manager to apply the one or more resource configurations to the computing resources;
an act of associating the event conditions with one or more policies that specify how the one or more resource configurations are to be applied to the computing resources;
an act of ascertaining that the one or more event conditions have occurred; and
in response to ascertaining that the one or more event conditions have occurred, an act of automatically executing one or more workflows that apply the resource configurations to the computing resources in accordance with the one or more policies to thereby configure the specified computing resources according the applied resource configurations.

2. The method of claim 1, further comprising:
an act of generating a template that includes the one or more resource configurations; and
an act of storing the template so that the one or more resource configurations may be used more than once to configure the computing resources.

3. The method of claim 1, wherein the computing resources are physical machines.

4. The method of claim 1, wherein the computing resources are virtual machines.

5. The method of claim 1, wherein the one or more event conditions are caused by a change to the infrastructure of the computer network.

6. The method of claim 1, wherein the one or more event conditions are caused by an application running on the computer network.

7. The method of claim 1, wherein ascertaining that the one or more event conditions have occurred comprises monitoring the computer network to determine if any changes to the computing resources of the computer network have occurred.

8. The method of claim 1, wherein ascertaining that the one or more event conditions have occurred comprises receiving a request or notification from the computing resource.

9. In a distributed network computing environment, a method for automatic end-to-end provisioning of computing resources, the method comprising:
an act of determining that a computing resource has made a change to a data center service fabric;
an act of accessing a first predefined profile template that includes a first resource configuration suitable to configure the computing resource in a first manner;
an act of executing a first workflow that automatically applies the first resource configuration to the computing resource so that the computing resource is configured in the first manner;
an act of monitoring the computing resource for the occurrence of a predefined event condition that indicates that a change in the first resource configuration is needed;
in response to the occurrence of the predefined event condition, an act of accessing a second predefined profile template that includes a second resource configuration suitable to configure the computing resource in a second manner; and
an act of executing a second workflow that automatically applies the second resource configuration to the computing resource so that the computing resource is configured in the second manner.

10. The method of claim 9, wherein the change to the service fabric of the data center includes adding new infrastructure to the data center or running an instance of an application in the data center.

11. The method of claim 9, wherein the computing resources are physical machines.

12. The method of claim 9, wherein the computing resources are virtual machines.

13. The method according to claim 9, wherein the first workflow configures the computing resource to be a storage device, wherein the event condition specifies that the computing resource cannot satisfy the capacity demands placed on it, and the second workflow configures the computing resource with additional storage capacity.

14. The method according to claim 9, wherein the first workflow configures the computing resource to be a compute device, wherein the event condition specifies that the computing resource cannot satisfy the capacity demands placed on it, and the second workflow configures the computing resource with additional compute capacity.

15. The method according to claim 9, wherein the first workflow configures or deploys applications that operate in the computing resource, wherein the event condition specifies that the computing resource cannot satisfy the operational demands of the applications, and the second workflow configures the computing resource to be able to support the operational demands of the applications.

16. The method according to claim 9, wherein the first and second profile templates are associated with one or more polices that specify how the resource configurations are to be applied to the computing resources.

17. A system, the system comprising:
one or more processors;
computing resources;
a profile generator configured to generate one or more profile templates, the profile templates including resources configurations suitable to configure the computing resources in a specified manner;
a profile bank configured to hold the one or more profile templates;
a policy based event generator configured to define event conditions whose occurrence cause the resource configurations of the profile templates to be applied to the computing resources and configured to define policies that specify how the resource configurations are to be applied;
an event monitor that monitors for the occurrence of the event conditions; and
a provisioning manager configured to associate a profile template with an event condition and configured to execute workflows that apply the resource configurations of a profile template to the computing resources to thereby configure the computing resources according the applied resource configurations.

18. The system of claim 17, wherein the computing resources are physical machines.

19. The system of claim 17, wherein the computing resources are virtual machines.

20. The system of claim 17, wherein the one or more event conditions are caused by a change to the infrastructure of the computer network.
